(19) United States
(12) Patent Application Publication
(10) Pub. No.: US 2011/0236521 A1
(43) Pub. Date: Sep. 29, 2011

(54) APPARATUS FOR MOLDING OPTICAL FIBER CONNECTOR

(75) Inventor: KUN-CHAN WU, Tu-Cheng (TW)

(73) Assignee: HON HAI PRECISION INDUSTRY CO., LTD., Tu-Cheng (TW)

(21) Appl. No.: 12/970,860

(22) Filed: Dec. 16, 2010

(30) Foreign Application Priority Data
Mar. 29, 2010 (TW) 99109276

(51) Int. Cl. G02B 6/26

(52) U.S. Cl. 425/446

(57) ABSTRACT

An apparatus for molding optical fiber connector is provided. The optical fiber connector includes a main body. The main body has a blind hole for receiving an optical fiber two opposite surfaces being substantially parallel with the blind hole, and a lens portion aligned with the blind hole. The apparatus comprises a molding cavity and an insert for forming the blind hole. The molding cavity includes a central portion for forming the main body, a lens-forming portion for forming the lens portion, and two lateral portions for forming the corresponding surfaces. The molding cavity includes a gate for introducing molding material into the molding cavity. The gate is connected to one of the lateral potions distal from the lens-forming portion.

### BACKGROUND

1. Technical Field

The present disclosure relates to an apparatus for molding an optical fiber connector.

2. Description of Related Art

Optical fiber connectors often include at least one blind hole and at least one lens integrated with the at least one blind hole. Each blind hole is behind a lens. The blind hole is used to receive an optical fiber to couple it with the lens to transform optical signals. An injection molding apparatus having a molding cavity is used to manufacture the optical fiber connectors, and an insert for molding the blind hole is defined in the molding cavity. A gate for inputting material of the optical fiber connector is defined in the molding cavity close to the molding. The shape and size of the gate must be within strict tolerances; otherwise, the characteristic of the optical fiber connector is poor. However, the above method cannot reliably produce the gate to desired tolerance.

### BRIEF DESCRIPTION OF THE DRAWINGS

Many aspects of the present molding apparatus for molding optical fiber connector can be better understood with reference to the following drawings. The components in the drawings are not necessarily drawn to scale, the emphasis instead being placed upon clearly illustrating the principles of the present apparatus for molding optical fiber connector. Moreover, in the drawings, like reference numerals designate corresponding parts throughout the several views.

FIG. 1 is a schematic view of an optical fiber connector.

FIG. 2 is a schematic view of an apparatus for molding the optical fiber connector shown in FIG. 1, according to a first embodiment.

FIG. 3 is a schematic view of another apparatus for molding an optical fiber connector, according to a second embodiment.

### DETAILED DESCRIPTION

Embodiments of the present apparatus for molding optical fiber connectors will now be described in detail below and with reference to the drawings.

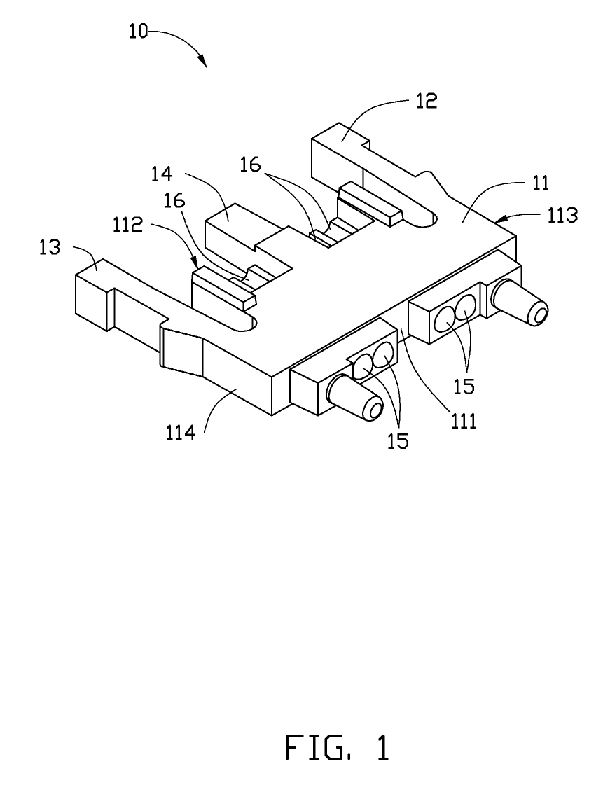

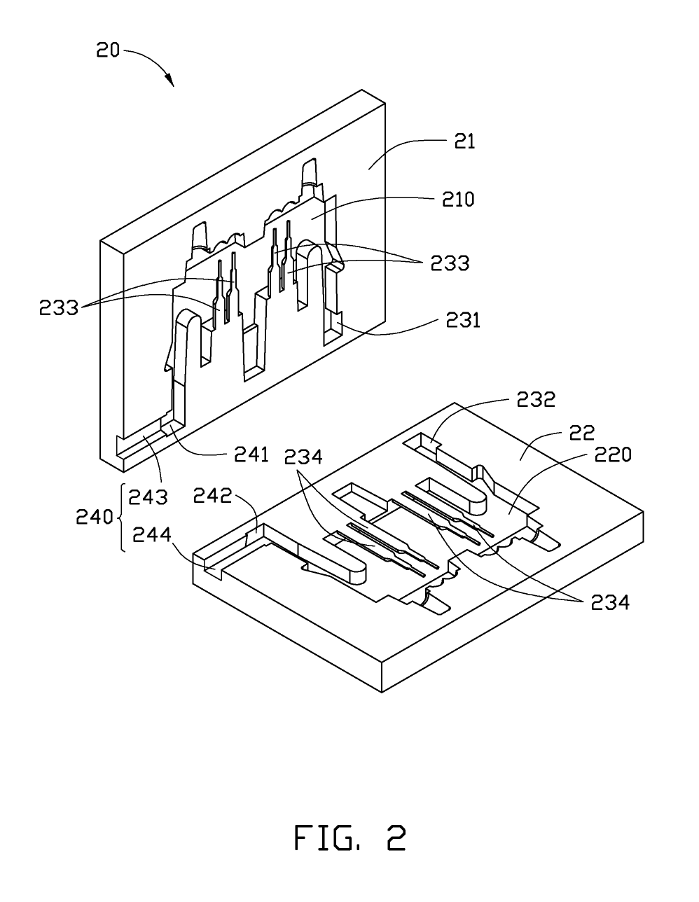

Referring to FIG. 1 and FIG. 2, an apparatus 20 for molding an optical fiber connector 10 in accordance with a first embodiment, is shown.

The optical fiber connector 10 includes a main body 11 and four lenses 15 integrated with the main body 11. The main body 11 includes a first arm 12, a second arm 13 opposite to the first arm 12, and a middle portion 14 between the first arm 12 and the second arm 13. The first arm 12 and second arm 13 are configured for holding the optical fiber connector 10 in place.

The main body 11 includes a first side surface 111, a second side surface 112 opposite to the first side surface 111, a third side surface 113, and a forth side surface 114 opposite to the third side surface 113. The first side surface 111 is connected with the third side surface 113 and the forth side surface 114. The four lenses 15 are defined on the first side surface 111. Four blind holes 16 are defined in the second side surface 112 and each extent from the second side surface 112 to the first side surface 111. Two of the four blind holes 16 are defined between the first arm 12 and the middle portion 14. Another two of the blind holes 16 are defined between the second arm 13 and the middle portion 14. Each of the blind holes 16 is configured for receiving an optical fiber. The lenses 15 are optically coupled to the optical fibers in the blind holes 16 respectively.

The first arm 12 and the second arm 13 extend from the second side surface 112 in the direction away from the lens 15. The first arm 12 and the second arm 13 are available for grasping by a user when manipulating the connector 10.

In applications where grasping portions are not need or can be other wise designed, the first arm 12 and the second arm 13 may be omitted.

The apparatus 20 includes an upper core 21 and a bottom core 22. The upper core 21 includes an upper molding cavity 210, a first upper cavity 231, a second upper cavity 241, four first mold cores 233, and a first lens-forming portion 235. The bottom core 22 includes a bottom molding cavity 220, a first bottom cavity 232, a second bottom cavity 242, four second mold cores 234, and a second lens-forming portion 236. The upper molding cavity 210 can mate with the bottom molding cavity 220 to form the main body 11 of the optical fiber connector 10. The first upper cavity 231 combines with the first bottom 232 as the mold for the first arm 12 of the optical fiber connector 10. The second upper cavity 241 can mate with the second bottom cavity 242 to form the mold for the second arm 13 of the optical fiber connector 10. The first mold core 233 combines with the second mold core 234 in order to form the blind hole 16 of the optical fiber connector 10. The first lens-forming portion 235 can mate with the second lens-forming portion 136 to form the lens 15.

An upper groove 243 is defined in the second upper cavity 241 and a bottom groove 244 is defined in the second bottom cavity 242. When the upper core 21 is mated to the bottom core 22, a gate 240 is defined by the upper groove 243 and the bottom groove 244.

In the injection process, the material for forming the optical fiber connector 10 flows into the upper molding cavity 210 and the bottom molding cavity 220 through the gate 240, and then the optical fiber connector 10 is molded.

It is understood that the upper groove 243 can be defined in the first upper cavity 231 and the bottom groove 244 is located in the second upper cavity 241.

In other embodiments, each of the first upper cavity 231, the second upper cavity 241, the first bottom cavity 232, and the second bottom cavity 242 may have a gate.

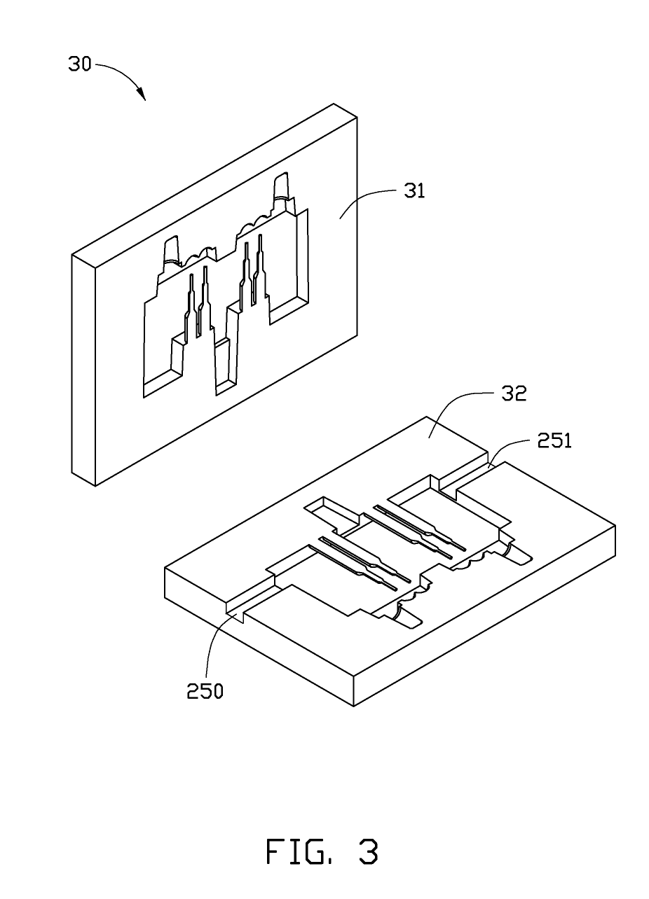

Referring to FIG. 3, in a second embodiment, in an optical fiber connector, the first arm 12 and the second arm 13 are omitted. The apparatus 30 has a first gate 250 and a second gate 251 on the bottom core 32 and the upper core 31 has no gate. The first gate 250 is defined in the portion of the bottom core 32 used for forming the third side surface 113 of the optical fiber connector 20, and the second gate 251 is defined in the portion of the bottom core 32 for forming the fourth side surface 114 of the optical fiber connector 20.

It is understood that the first gate 250 and the second gate 251 can instead be formed in the upper core 31.

It is also understood that in other embodiments, the apparatus 30 may have just one of the first gate 250 and the second gate 251 when desired tolerances can be met for a particular application environment with just one gate.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. An apparatus for molding an optical fiber connector, the optical fiber connector including a main body and a lens portion, the main body having a blind hole for receiving an optical fiber and two opposite lateral surfaces being substantially parallel with the blind hole, the lens portion aligned with the blind hole, the apparatus comprising a molding cavity and an insert for forming the blind hole, the molding cavity including a central portion for forming the main body, a lens-forming portion for forming the lens portion, and two lateral portions for forming the corresponding lateral surfaces, the molding cavity including a gate for introducing molding material into the molding cavity therethrough, the gate connected to one of the lateral portions distal from the lens-forming portion.

2. The apparatus as described in claim 1, wherein the apparatus further comprises an upper molding plate and a lower molding plate, the upper molding plate and the lower molding plate cooperatively form the molding cavity.

3. The apparatus as described in claim 2, wherein the upper molding plate includes a first groove and the lower molding plate includes a second groove, the first and second grooves cooperatively constituting the gate.

4. The apparatus as described in claim 3, wherein the first and second grooves extend in a direction distinct from lengthwise directions of the lateral portions.

5. An apparatus for molding an optical fiber connector, the optical fiber connector including a main body, a lens portion, and two arms extending from the main body, the arms located at opposite sides of the main body, the main body having a blind hole for receiving an optical fiber, the lens portion aligned with the blind hole, the apparatus comprising a molding cavity and an insert for forming the blind hole, the molding cavity including a central portion for forming the main body, a lens-forming portion for forming the lens portion, and two lateral portions for forming the corresponding arms, the molding cavity including a gate for introducing molding material into the molding cavity therethrough, the gate connected to an end of one of the lateral portions distal from the lens-forming portion.

6. The apparatus as described in claim 5, wherein the apparatus further comprises an upper molding plate and a lower molding plate, the upper molding plate and the lower molding plate cooperatively form the molding cavity.

7. The apparatus as described in claim 6, wherein the upper molding plate includes a first groove and the lower molding plate includes a second groove, the first and second grooves cooperatively constituting the gate.

8. The apparatus as described in claim 7, wherein the first and second grooves extend in a direction distinct from lengthwise directions of the lateral portions.
